(19) United States
(12) Patent Application Publication
(10) Pub. No.: US 2010/0177359 A1
(43) Pub. Date: Jul. 15, 2010

(54) MAINTENANCE WORK SUPPORT DEVICE, MAINTENANCE WORK SUPPORT METHOD, AND PROGRAM

(75) Inventors: Masami MIYAZAKI, Itami (JP); Junichi TAMAOKI, Sakai (JP); Ryohei HAYAKAWA, Shirako (JP); Masahiro KAMASE, Chotu (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/631,291

(22) Filed: Dec. 4, 2009

(30) Foreign Application Priority Data
Jan. 14, 2009 (JP) 2009-005577

(51) Int. Cl. H04N 1/00

(52) U.S. Cl. 358/406

(57) ABSTRACT

A maintenance work support device which computes replacement information of a part configuring a device and supports maintenance work of the device includes: a storage unit storing information; and a control unit controlling the maintenance work support device according to the stored information. The storage unit comprises: a unit storing identification information and a replacement state for improving part quality as quality information; a unit storing device identification information and a replacement state by a past part failure as replacement history information; and a unit storing a part replacement record associated with a device use state as replacement record information. The control unit comprises a unit retrieving quality information, replacement history information, and part replacement record information based on identification information and a use state of an inspection target device and computes information of a part that needs to be replaced as replacement information based on the retrieval result.

### BACKGROUND

1. Technical Field

The present invention relates to a technique of supporting maintenance work such as part replacement of an inspection target device such as a printing device.

2. Related Art

In recent years, users of various types of businesses have used printing devices such as copying machines or facsimile devices. Maintenance work of regularly replacing parts in order to prevent failures in advance and maintain printing quality is performed on these printing devices. Various techniques for supporting the maintenance work such as part replacement have been developed.

For example, as disclosed in JP-A-63-173677, a printing device measures an operation history or an operation time and, when the part replacement period is reached, makes a display on a display panel based on the measured operation time or history.

JP-A-2001-180092 discloses a printing device that automatically determines a replacement period of periodically replaced parts in consideration of the number of recent printing copies and makes a notification of this in advance.

JP-A-2007-109056 discloses a part management system which predicts a part replacement period based on part information including replacement period information previously set for parts which configure the device and the past replacement state of parts which configure the device used by a user.

However, the part replacement support technique for conventional printing devices is aimed at part replacement for mainly preventing failures and has a problem in that it cannot perform part replacement in response to recognition of or requirements of use (installation) environments and printing qualities which vary according to the user. For example, even when the use time of a part is not up to the life span (failure) of the part, there is a case in which replacement is needed in order to satisfy the printing quality required by the business type of the user, and the conventional technique has difficulty coping with this case.

Further, at the time of inspection, when a maintenance worker explains to the user that part replacement is needed to prevent a failure of a part or improve the printing quality even though a part has not had a failure, it is difficult to explain when to replace a part and why it is necessary, and there may be a case in which the maintenance worker cannot skillfully give the explanation depending on the degree of repair and customer service experience of the maintenance worker.

### SUMMARY

An advantage of some aspects of the invention is that it computes information of a part which needs to be replaced or inspected in consideration of the installation state or quality requirements of the user, reduces differences in the quality or the work efficiency of the maintenance work resulting from differences in the maintenance worker's experience, and supports the work of the maintenance worker.

According to an aspect of the invention, there is provided a maintenance work support device which computes replacement information of a part which configures a device and supports maintenance work of the device, including: a storage unit which stores various pieces of information; and a control unit which controls the maintenance work support device according to information stored in the storage unit, wherein the storage unit comprises: a quality information storage unit which stores identification information and a replacement state for improving the quality of a part which configures the device as quality information; a replacement history information storage unit which stores identification information of the device and a replacement state by a past failure of a part which configures the device as replacement history information; and a replacement record information storage unit which stores a replacement record of a part which configures the device and a use state of the device in association with each other as replacement record information, and the control unit includes a replacement information computation unit which retrieves quality information, replacement history information, and replacement record information of a part which configures the device based on identification information and a use state of a device which is an inspection target and computes information of a part which configures the device and needs to be replaced as replacement information based on the retrieval result.

The quality information includes information representing whether or not a part is a part to be replaced in order to improve the quality.

According to the invention, information of a part which needs to be replaced in the device which is the inspection target, that is, the replacement information, is computed based on the part quality information, the past part replacement history, and the replacement record corresponding to the use state of the device of the same model as the device which is the inspection target.

Further, the replacement record can be corrected in consideration of the use state of the device or the business type of the user, and the part replacement information can be computed according to the use state of the device or the business type of the user.

Further, according to the invention, a program causing a computer to function as the maintenance work support device is provided.

According to another aspect of the invention, there is provided a maintenance work support method of computing replacement information of a part which configures a device and supporting maintenance work of the device, including: storing identification information and a replacement state for improving the quality of a part which configures the device as quality information; storing identification information of the device and a replacement state by a past failure of a part which configures the device as replacement history information; storing a replacement record of a part which configures the device and a use state of the device in association with each other as replacement record information; and retrieving quality information, replacement history information, and replacement record information of a part which configures the device based on identification information and a use state of a device which is an inspection target and computing information of a part which configures the device and needs to be replaced as replacement information based on the retrieval result.

According to the invention, a worker performing the maintenance work can rapidly and accurately acquire information of a part which needs to be replaced or inspected in consideration the installation state or quality requirements of a user. Since it can be understood whether the part replacement aims to prevent a failure or to improve the quality, the user can understand the maintenance work, leading to improved efficiency or quality in the maintenance work.

### BRIEF DESCRIPTION OF THE DRAWINGS

The invention will be described with reference to the accompanying drawings, wherein like reference numbers represent like elements.

FIG. 1 is a block diagram of a maintenance work support system.

FIG. 2 is a flowchart illustrating a procedure of part replacement computation processing through a maintenance work support device.

FIG. 3 is a view illustrating countermeasure part information.

FIG. 4 is a view illustrating an example of a retrieval result of countermeasure part information.

FIG. 5 is a view illustrating replacement history information.

FIG. 6 is a view illustrating an example of a retrieval result of replacement history information.

FIG. 7 is a view illustrating replacement record information.

FIG. 8 is a view illustrating a retrieval result using replacement record information.

FIG. 9 is a view illustrating replacement information.

FIG. 10 is a flowchart illustrating a procedure of replacement information computation processing of a maintenance work support device according to a second embodiment.

FIG. 11 is a view illustrating an installation rank.

FIG. 12 is a view illustrating replacement record information in which an installation rank is considered.

FIG. 13 is a view illustrating a retrieval result using replacement record information in which an installation rank is considered.

FIG. 14 is a view illustrating replacement information in which installation information is considered.

FIG. 15 is a view illustrating replacement record information in which an installation rank is considered according to a third embodiment.

FIG. 16 is a view illustrating a retrieval result using replacement record information in which an installation rank is considered.

FIG. 17 is a view illustrating replacement information in which installation information is considered.

FIG. 18 is a view illustrating replacement information including firmware version information.

FIG. 19 is a view illustrating replacement information including price information of a replacement part.

FIG. 20 is a view illustrating replacement information including replacement work time for a replacement part.

FIG. 21 is a view illustrating replacement information including a preventive degree of a replacement part.

FIG. 22 is a view illustrating an example of a part classification of an inspection target device.

FIG. 23 is a view illustrating a classification of a part according to business type.

### DESCRIPTION OF EXEMPLARY EMBODIMENTS

Hereinafter, exemplary embodiments of a maintenance work support device according to the invention will be described in detail with reference to the accompanying drawings. In the following description and accompanying drawings, like reference numerals denote like parts, and thus duplicated description is omitted.

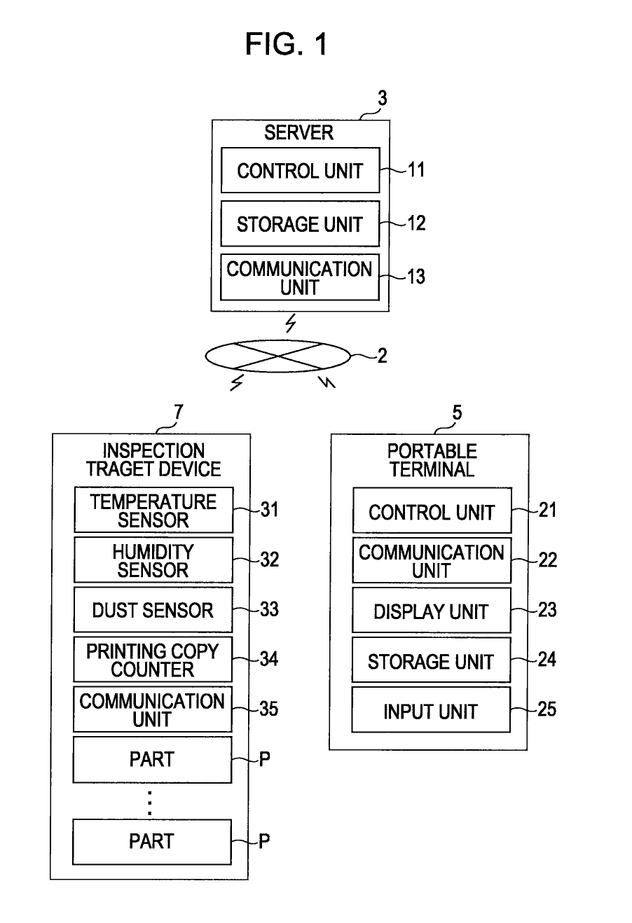

FIG. 1 is a block diagram of a maintenance work support system. The maintenance work support system includes a server 3 as a maintenance work support device, a portable terminal 5, an inspection target device 7 as a maintenance work target, and a network 2. The server 3 and the portable terminal 5, and the server 3 and the inspection target device 7 are connected to be communicable with each other through the network 2 in a wireline or wireless manner. The network 2 is a network such as the Internet or a local area network (LAN).

The server 3 is a computer and includes a control unit 11, a storage unit 12, and a communication unit 13. The control unit 11 is a central processing unit (CPU) or a microprocessor, controls the respective components such as the storage unit 12 and the communication unit 13, and performs processing as a part replacement information computing unit which will be described later. The storage unit 12 is a storage device such as a non-volatile memory, a volatile memory, or a hard disk and stores various pieces of information (a database) which will be described later or a program for performing processing of the part replacement information computing unit.

The control unit 11 reads out a program stored in the storage unit 12 such as a non-volatile memory and performs processing as the part replacement information computing unit. The communication unit 13 transmits or receives data to or from the portable terminal 5 or the inspection target device 7 through the network 2. Even though not illustrated in FIG. 1, the server 3 may include an input unit for receiving data input or an output unit for outputting a processing result.

The portable terminal 5 is a terminal device such as a computer, a personal digital assistant (PDA), a portable telephone, and a personal handy-phone system (PHS) and includes a control unit 21, a communication unit 22, a display unit 23, a storage unit 24, and an input unit 25. The control unit 21 controls the communication unit 22, the display unit 23, the storage unit 24, and the input unit 25. The communication unit 22 transmits or receives data to or from the server 3 through the network 2. The display unit 25 displays a processing result received from the server 3. The storage unit 24 stores information for the inspection target device 7 input from the input unit 25 or the processing result received from the server 3. The input unit 25 receives input information for the inspection target device 7, for example, an identification number (a serial number or a manufacturing number) of the inspection target device 7.

The inspection target device 7 is a device such as a printing device (for example, a printer) or a copying machine or a facsimile which has a printing function and a device which is installed in each use environment of a user and is subject to periodical maintenance. The inspection target device 7 includes sensors such as a temperature sensor 31, a humidity sensor 32, and a dust sensor 33, a printing copy counter 34, a communication unit 35, and one or more parts P to be inspected and replaced (which is a maintenance target).

The temperature sensor 31 measures the temperature of a place where the inspection target device 7 is installed. The humidity sensor 32 measures humidity in a place where the inspection target device 7 is installed. The dust sensor 33 measures the amount of dust around the inspection target device 7, for example, the spatial density of dust and measures to what extent a use environment of the inspection target device 7 is dirty. The sensors installed in the inspection target device 7 are not limited to the three types illustrated in FIG. 1 and may be appropriately increased or decreased.

The printing copy counter 34 measures the number of printing copies printed by the inspection target device 7. The communication unit 35 transmits information such as the number of printing copies measured by the printing copy counter 34 to the server 3 through the network 2. For example, the communication unit 35 acquires detection results or count results of the temperature sensor 31, the humidity sensor 32, the dust sensor 33, and the printing copy counter 34 at a regular interval and transmits the detection results or the count results to the server 3. This transmission may be performed when the count result of the printing copy counter 34 reaches a fixed copy number or performed in response to a transmission request transmitted from the server 3 at the time of periodical inspection.

The part P is a part which configures the inspection target device 7 and a part as a part replacement (maintenance) target.

The parts are divided into a countermeasure part and a preventive part.

The countermeasure part is a part in which a possibility that a failure will occur within a certain period is lower than a reference value (a reference value of a failure incidence), but printing performance (quality) could be improved by replacement. For example, in the case of an antivibration rubber, the antivibration rubber of the countermeasure part has a material or a structure which is different from an antivibration rubber of a standard specification and has a higher antivibration performance than the standard specification. That is, even in the antivibration rubber of the standard specification, printing satisfying a certain quality criterion can be performed, and the failure incidence is also equal to or lower than the reference value, but when replaced with the antivibration rubber of the countermeasure part, the antivibration performance is improved, and the printing quality is improved.

The preventive part is a part in which there is no failure in the current stage at the time of inspection, but a possibility that a failure will occur within a fixed period is higher than the reference value (the reference value of the failure incidence).

In the maintenance, in order to prevent a failure of the part P of the inspection target device 7, the part P may be replaced, but the part P may be replaced with the countermeasure part according to the business type or use environment of the user of the inspection target device 7 to thereby improve the printing quality. The maintenance work support device performs the maintenance support according to various use environments of the inspection target device 7 or various business types of the user.

Next, an operation of the server 3 as the maintenance work support device will be described.

For example, described is a case in which the maintenance worker who performs the maintenance work of the printing device as the inspection target device 7 visits a place where the inspection target device 7 is installed and receives information (for example, identification information) of the inspection target device 7 and transmits the information to the server 3 by using the portable terminal 5, and the server 3 measures part replacement information of the inspection target device 7 at the time of current inspection based on the information.

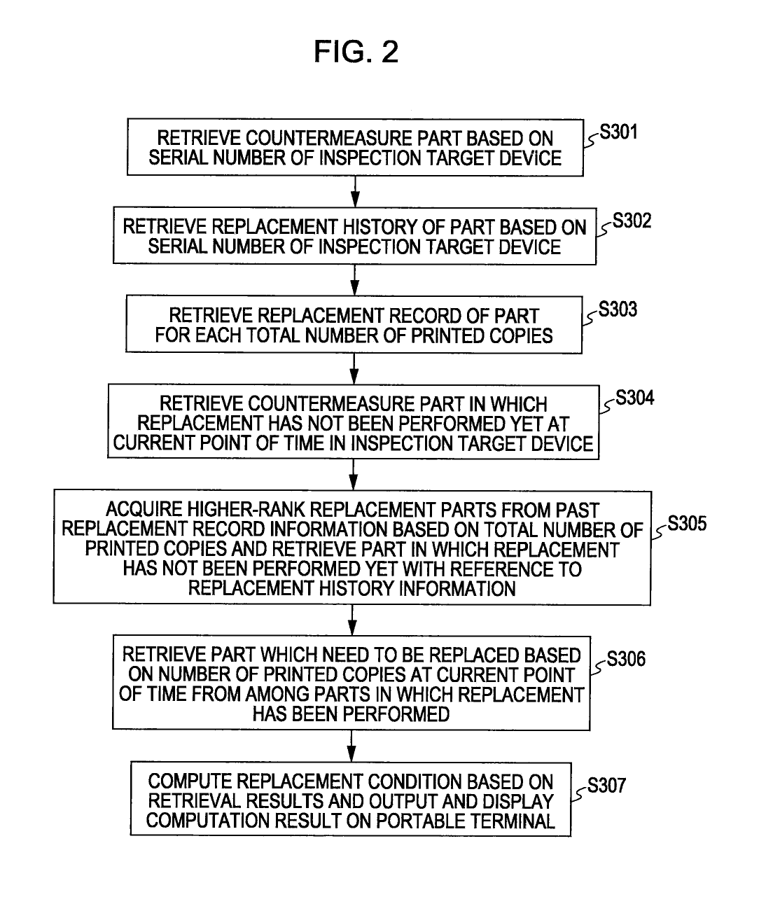

FIG. 2 is a flowchart illustrating a procedure of part replacement information computation processing through the server 3. The main processing body is the control unit 11 of the server 3 and corresponds to the replacement information computation unit.

The control unit 11 retrieves the countermeasure part of the inspection target device 7 based on the serial number of the inspection target device 7 (step S301 of FIG. 2). The serial number of the inspection target device 7 is input from the input unit 25 of the portable terminal 5 by the maintenance worker and transmitted to the communication unit 13 of the server 3 by the communication unit 22. Further, the total number of printed copies of the inspection target device 7 at the time of inspection is transmitted to the server 3 from the inspection target device 7 or the portable terminal 5.

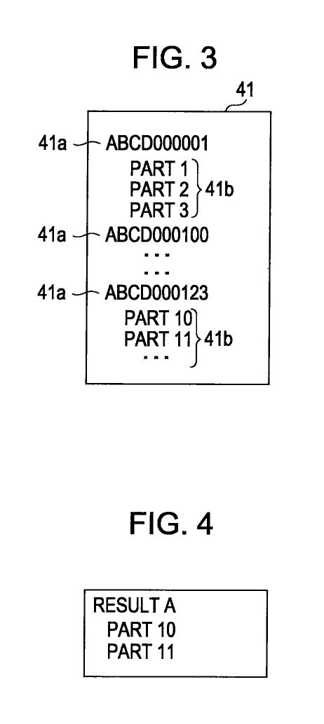

FIG. 3 is a view illustrating countermeasure part information 41 stored in the storage unit 12 of the server 3. The countermeasure part information 41 includes a serial number 41a as an identification number of the inspection target device 7 and countermeasure part information 41b, which configures the inspection target device 7, which are associated with each other.

FIG. 4 is a view illustrating information obtained by retrieval of step S301. In step S301, the control unit 11 retrieves countermeasure part information of the inspection target device 7 corresponding to the serial number of the inspection target device 7 received by the communication unit 13. As illustrated in FIG. 4, when the serial number of the inspection target device 7 is ABCD000123, a part 10 and a part 11 as the countermeasure parts are obtained as the retrieval result. This retrieval result is referred to as a result A.

Next, the control unit 11 retrieves a part replacement history based on the serial number of the inspection target device 7 (step S302 of FIG. 2).

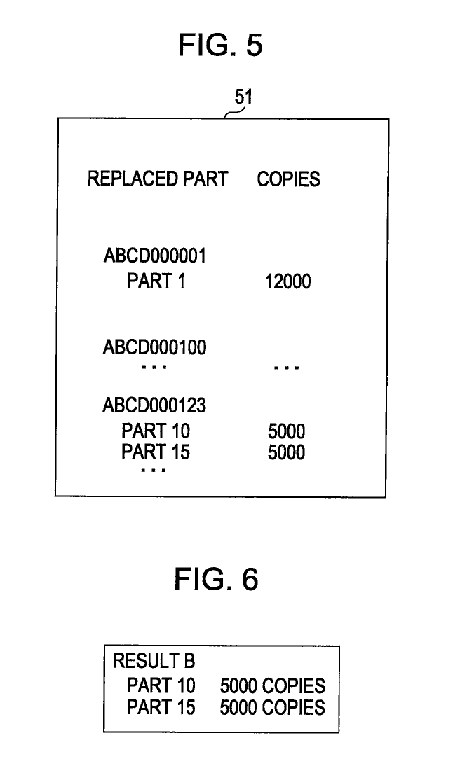

FIG. 5 is a view illustrating replacement history information 51 stored in the storage unit 12 of the server 3. The replacement history information 51 includes the serial number of the inspection target device 7, a replacement history representing a part which has been replaced in the past among parts which configure the inspection target device 7, and information representing the number of printed copies at a point of time in which the part replacement is performed.

FIG. 6 is a view illustrating information obtained by retrieval of step S302. As illustrated in FIG. 6, for example, in the inspection target device 7 with the serial number ABCD000123, information that the part 10 and a part 15 were replaced at the point of time at which the number of printed copies reached 5,000 copies is obtained as the retrieval result. This retrieval result is referred to as a result B.

Next, the control unit 11 retrieves a part replacement record of each total number of printed copies (step S303 of FIG. 2).

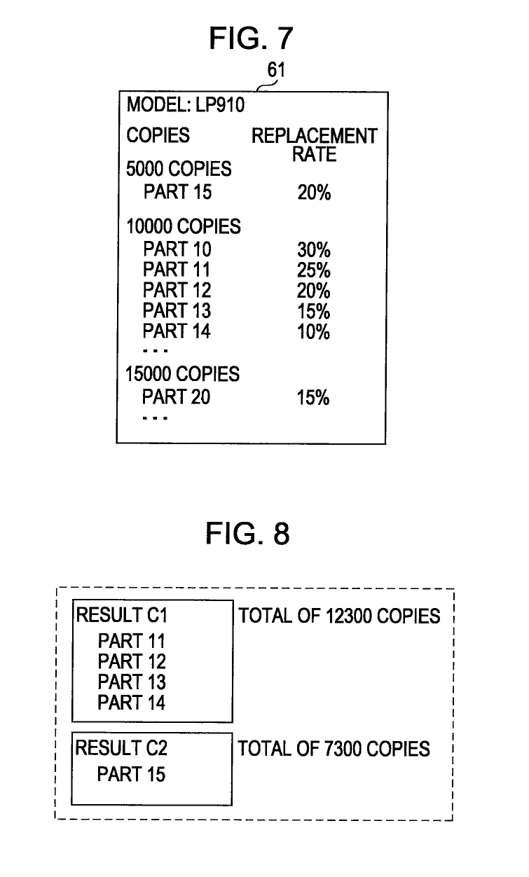

FIG. 7 is a view illustrating replacement record information 61 stored in the storage unit 12 of the server 3. The replacement record information 61 is information in which the number of printed copies (for example, the total number of printed copies) when the part replacement is performed, a part name, and a part replacement rate are stored for each model name. The model name can be retrieved through the serial number of the inspection target device 7 based on data in which the model name and the serial number are associated with each other. For example, a model associated with the serial number ABCD000123 is LP910.

In FIG. 7, when the number of printed copies is 5,000 copies and the replacement rate of the part 15 is 20%, the replacement record in which 20 of 100 inspection target devices which have reached 5,000 printed copies in this model have replaced the part 15 is illustrated.

In FIG. 7, a part in which the replacement rate is equal to or higher than a predetermined reference value is stored as a target. Here, a part in which the replacement rate is equal to or higher than 10% is stored as a target.

Next, the control unit 11 retrieves the countermeasure part in which the replacement for the inspection target device 7 has not been performed yet (step S304 of FIG. 2). In this process, the countermeasure part in which the replacement has not been performed yet is retrieved from among the countermeasure parts retrieved in step S301 with reference to the past replacement record retrieved in step S302. That is, through the processing of step S304, the part replacement state for improving the quality of the inspection target device 7 is retrieved. For example, this is processing in which the parts of the result B illustrated in FIG. 6 are excluded from the parts of the result A illustrated in FIG. 4, and as a result, the parts 11 is retrieved as the countermeasure part in which the replacement is not performed yet.

Next, the control unit 11 acquires higher-rank replacement parts from the replacement record information 61 based on the total number of printed copies and retrieves the parts in which the replacement is not performed yet with reference to the replacement history information 51 (step S305 of FIG. 2). Here, what the replacement rate ranks high means that the degree to which the replacement is desired is high, and the higher the replacement rate is, the higher the replacement part ranks.

The total number of printed copies of the inspection target device 7 at the time of current inspection is 12,300 copies, and the total number of the printed copies is transmitted to the server 3 from the portable terminal 5. Since the total number of printed copies is 12,300 copies, a part 11, a part 12, a part 13, and a part 14 in which a part 10 and a part 15 in which a replacement history is stored in the replacement history information 51 are excluded from among the part 10, the part 11, the part 12, the part 13, and the part 14 having the suggested replacement record of 10,000 copies of the replacement record information 61 are retrieved as the retrieval result of step S305. FIG. 8 is a view illustrating the retrieval result. The result of processing by step S305 is a result C1 illustrated in FIG. 8.

Next, the control unit 11 retrieves parts which need to be replaced based on the number of printed copies at this point of time with reference to the replacement history information 51 (step S306 of FIG. 2). For example, the total number of current printed copies is 12,300 copies, and a history in which the parts 10 and the parts 15 have been replaced at 5,000 copies is included in the replacement history information 51. This means that the number of printed copies of the parts 10 and the parts 15 from the time of previous replacement to the current point of time is 12,300-5,000=7,000 copies. Referring to the replacement record information 61 illustrated in FIG. 7, there is a record in which the replacement rate of the part 15 at 5,000 copies is 20%, and the number of printed copies from the time of the previous replacement to the current point of time is 7,000 copies and exceeds 5,000 copies. Therefore, the part 15 is recognized as a part which needs to be replaced. The processing result of step S306 becomes a result C2 illustrated in FIG. 8.

Next, the control unit 11 computes replacement information based on the retrieval results and transmits and displays the computation result on the portable terminal (step S307 of FIG. 2).

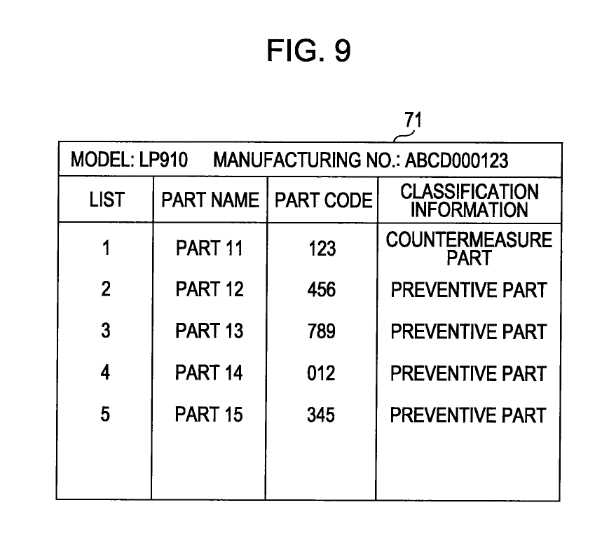

FIG. 9 is a view illustrating an example in which replacement information 71 is computed and displayed on the display unit 23 of the portable terminal 5. The control unit 11 transmits the retrieval results of step S304, step S305, and step S306 to the portable terminal 5 as the replacement information 71 and displays the retrieval results on the display unit 23. As illustrated in FIG. 9, the part 11 (the result of step S304) is displayed as the countermeasure part, and the part 12, the part 13, the part 14, and the part 15 computed from the results of step S305 and step S306 are displayed as the preventive part in the order of highest to lowest replacement rate.

In the present embodiment described above, it is possible to acquire and display whether the part replacement is performed to improve the quality or to prevent a failure in advance as the replacement information 71 as well as a part which is desired to be replaced.

The maintenance worker can determine whether to replace the part of the inspection target device 7 and efficiently perform the maintenance work by using the replacement information 71 displayed on the portable terminal 5 as a clue.

Further, it is possible to display the respective retrieval results of step S302 to step S306 illustrated in FIG. 2 on the display unit 23 of the portable terminal 5, respectively.

Next, a second embodiment of the maintenance work support device will be described.

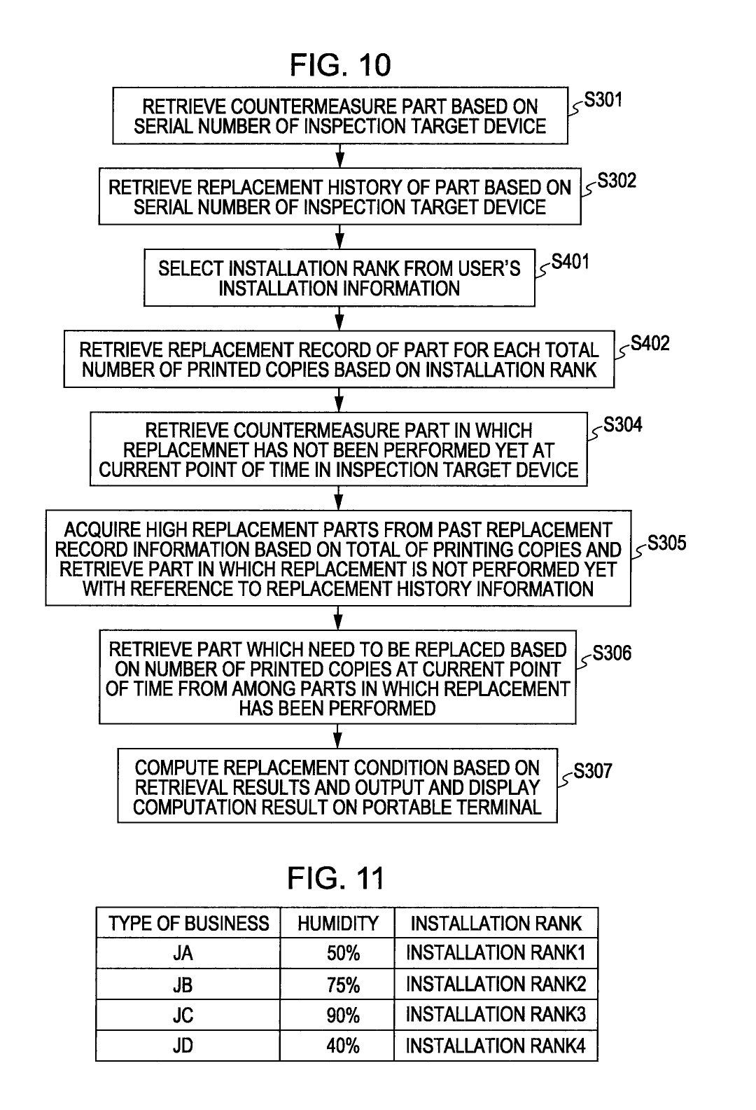

FIG. 10 is a flowchart illustrating a procedure of replacement information computation processing of the server 3 according to the second embodiment. Step S401 and step S402 are different from those of replacement information computation processing illustrated in FIG. 2. In the second embodiment, an installation rank is determined from installation information of the inspection target device 7 of each user, and part replacement information is computed in consideration of the installation rank.

In step S401 of FIG. 10, the control unit 11 selects an installation rank to be applied from user installation information.

FIG. 11 is a view illustrating an example of the installation rank. As illustrated in FIG. 11, the installation rank is determined according to installation information such as an installation environment of the inspection target device 7, the user's use state, and the printing quality required by the user. For example, when the business type of the user of the inspection target device 7 is JA, humidity (a detection result of the humidity sensor 32) in the use environment of the inspection target device 7 is 50% and the installation rank is displayed as installation rank 1. Information for the installation rank is stored in the storage unit 12. Here, an example in which the installation rank is determined according to installation information such as business type and humidity is given, but the installation rank may be appropriately determined by employing and combining temperature, dustiness, and other conditions as installation information.

In step S402 of FIG. 10, the control unit 11 retrieves the part replacement record of each total number of copies based on the installation rank. Processing of step S402 corresponds to step S303 illustrated in FIG. 2.

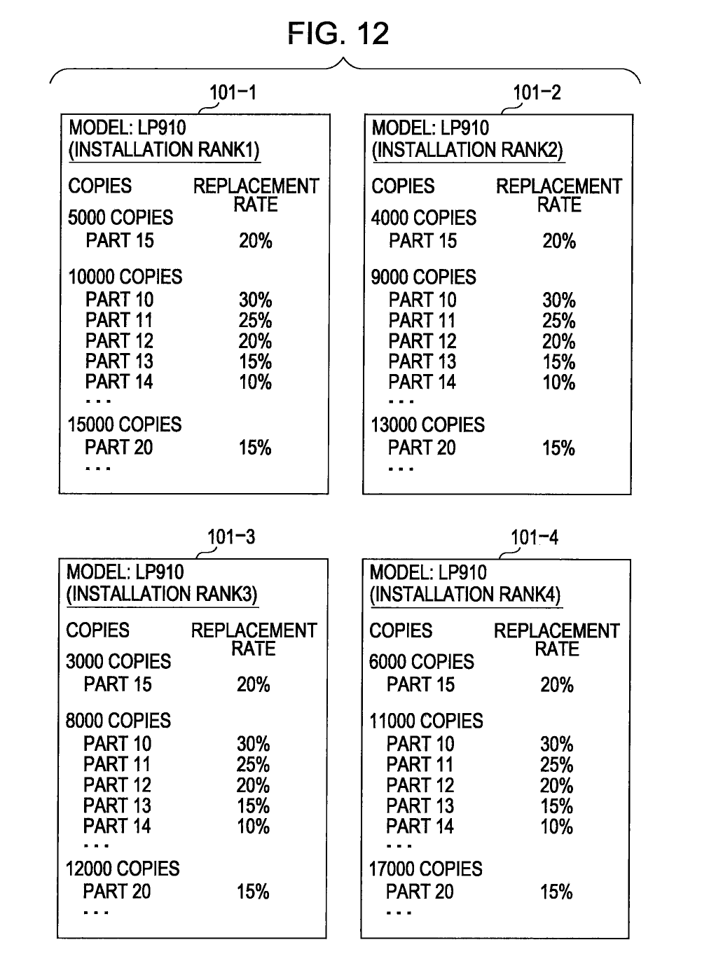

FIG. 12 is a view illustrating replacement record information determined for each installation rank. As illustrated in FIG. 12, replacement record information 101-1 is stored in association with an installation rank 1, replacement record information 101-2 is stored in association with an installation rank 2, replacement record information 101-3 is stored in association with an installation rank 3, and replacement record information 101-4 is stored in association with an installation rank 4. In the installation rank information 101-1 to 101-4, respective parts have the same replacement rate, but the total number of copies as a replacement record depends on the installation rank. In an installation rank 3 illustrated in FIG. 11, humidity is 90%, and the use environment of the inspection target device 7 is a very severe environment. When the replacement rate of the part 15 is 20%, the total number of printed copies is 5000 copies in the replacement record information 101-1, while the total number of copies is 3000 copies in the replacement record information 101-3 of the installation rank 3.

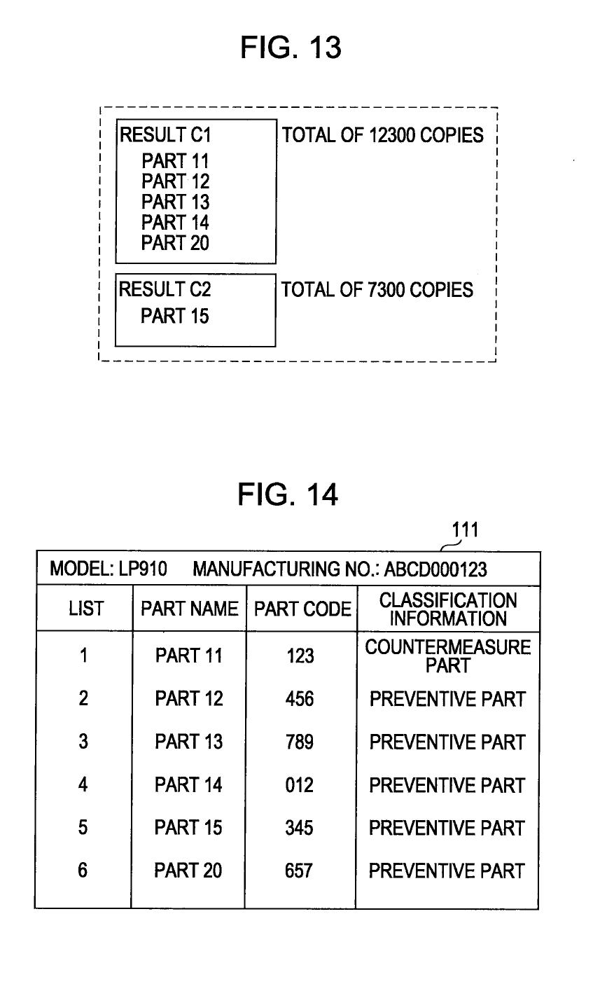

Here, when the installation rank of the inspection target device 7 is the installation rank 3, processing of step S304 to step S307 is performed with reference to the replacement record information 101-3 illustrated in FIG. 12. FIG. 13 is a view illustrating the retrieval results of step S305 and step S306 when the installation rank is considered.

Here, when the total number of printed copies of the inspection target device 7 at the time of current inspection is 123,000 copies, the part 11, the part 12, the part 13, the part 14, and the part 20 in which the part 10 and the part 15 (see FIG. 6) in which the replacement history is stored in the replacement history information 51 are excluded from among the part 10, the part 11, the part 12, the part 13, the part 14, the part 15, and the part 20 suggested as parts having a high replacement rate (for example, a replacement rate of equal to or more than 10%) are retrieved as the retrieval results of the result C1 of step S305 with reference to the replacement record of 3,000 copies, 8,000 copies, and 12,000 copies of the replacement record information 101-3. Further, the part 15 is retrieved as the result C2 similarly to the first embodiment.

As a result of performing processing of step S304 to step S307 by using the replacement record information 101-3 illustrated in FIG. 12, replacement information illustrated in FIG. 14 is computed. The replacement information 111 illustrated in FIG. 14 is replacement information in which the installation rank is considered. The replacement information 111 is displayed on the display unit 23 of the portable terminal 5, and the maintenance worker may perform the part replacement work with reference to the replacement information 111.

In the replacement record information illustrated in FIG. 12, the total number of printed copies of all parts is changed according to the installation rank, but the total number of printed copies of a certain part may be changed.

Next, a third embodiment of the maintenance work support device will be described.

Even in the third embodiment, the server 3 computes a part replacement state according to a procedure illustrated in FIG. 10 in consideration of the installation rank of FIG. 11 similarly to the second embodiment.

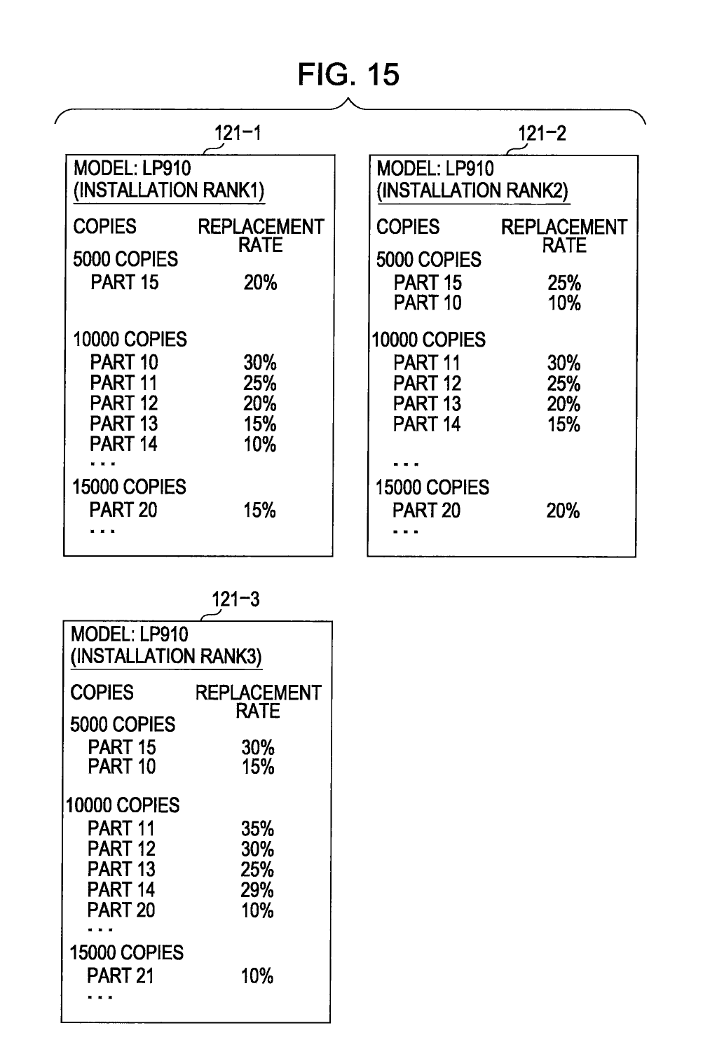

FIG. 15 is a view illustrating replacement record information determined for each installation rank according to the third embodiment. As illustrated in FIG. 15, replacement record information 121-1 is applied to installation information of an installation rank 1, replacement record information 121-2 is applied to installation information of an installation rank 2, and replacement record information 121-3 is applied to installation information of an installation rank 3. In the replacement record information 121-1 to 121-3, the replacement rate for the total number of printed copies depends on the installation rank.

For example, when a case in which the replacement rate is equal to or more than 10% is stored as replacement record information, in the case of the parts 10, in the replacement record information 121-1 of the installation rank 1, the replacement rate is 30% when the total number of printed copies is 10,000 copies, while in the replacement record information 121-3 of the installation rank 3, the replacement rate is 15% when the total number of printed copies is 5,000 copies. That is, since the replacement record information is changed according to the installation rank, the replacement information computed based on the replacement record information is also changed.

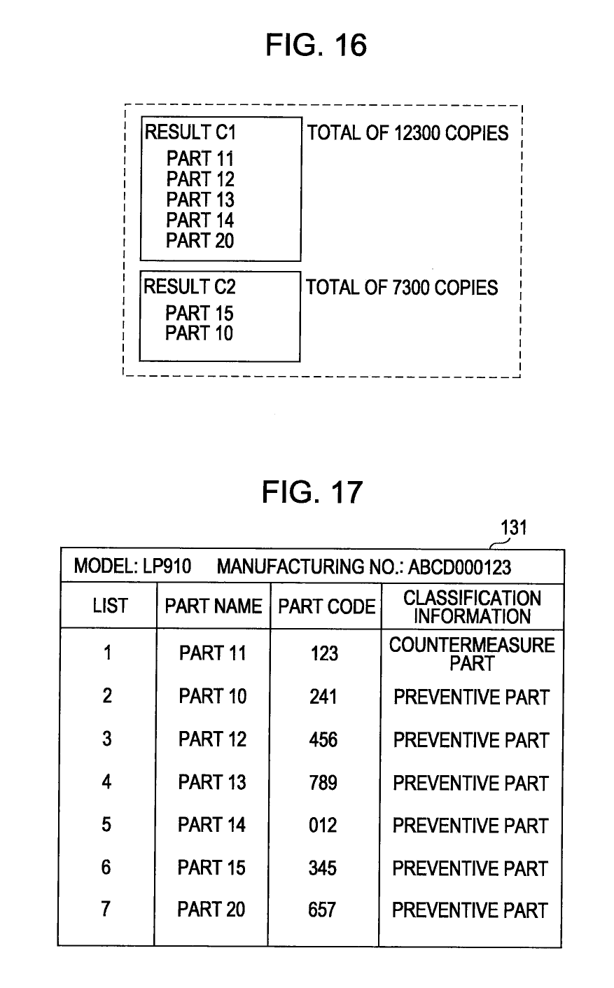

Here, when the installation rank of the inspection target device 7 is the installation rank 3, processing of step S304 to step S307 is performed by using replacement record information 121-3 illustrated in FIG. 15. FIG. 16 is a view illustrating the retrieval results of step S305 and step S306 when the installation rank is considered.

Here, when the total number of printed copies of the inspection target device 7 at the time of current inspection is 123,000 copies, the part 11, the part 12, the part 13, the part 14, and the part 20 in which the part 10 and the part 15 (see FIG. 6) in which the replacement history is stored in the replacement history information 51 are excluded from among the part 10, the part 11, the part 12, the part 13, the part 14, the part 15, and the part 20 suggested as having the replacement record of 5,000 copies and 10,000 copies of the replacement record information 121-3 are retrieved as the retrieval result “result C1” of step S305. Further, since the total number of printed copies since the time of the previous replacement is 7,000 copies, the parts 15 and the parts 10 of 5,000 copies of the replacement record information 121-3 are retrieved as the result C2.

As a result of performing processing of step S304 to step S307 by using the replacement record information 121-3 illustrated in FIG. 15, replacement information illustrated in FIG. 17 is computed. The replacement information 131 illustrated in FIG. 17 is replacement information in which the installation rank is considered. The replacement information 131 is displayed on the display unit 23 of the portable terminal 5, and the maintenance worker may perform the part replacement work with reference to the replacement information 131.

In the replacement record information illustrated in FIG. 15, the replacement rate of all parts is changed according to the installation rank, but the replacement rate of only a certain part may be changed.

Next, a fourth embodiment of the maintenance work support device will be described.

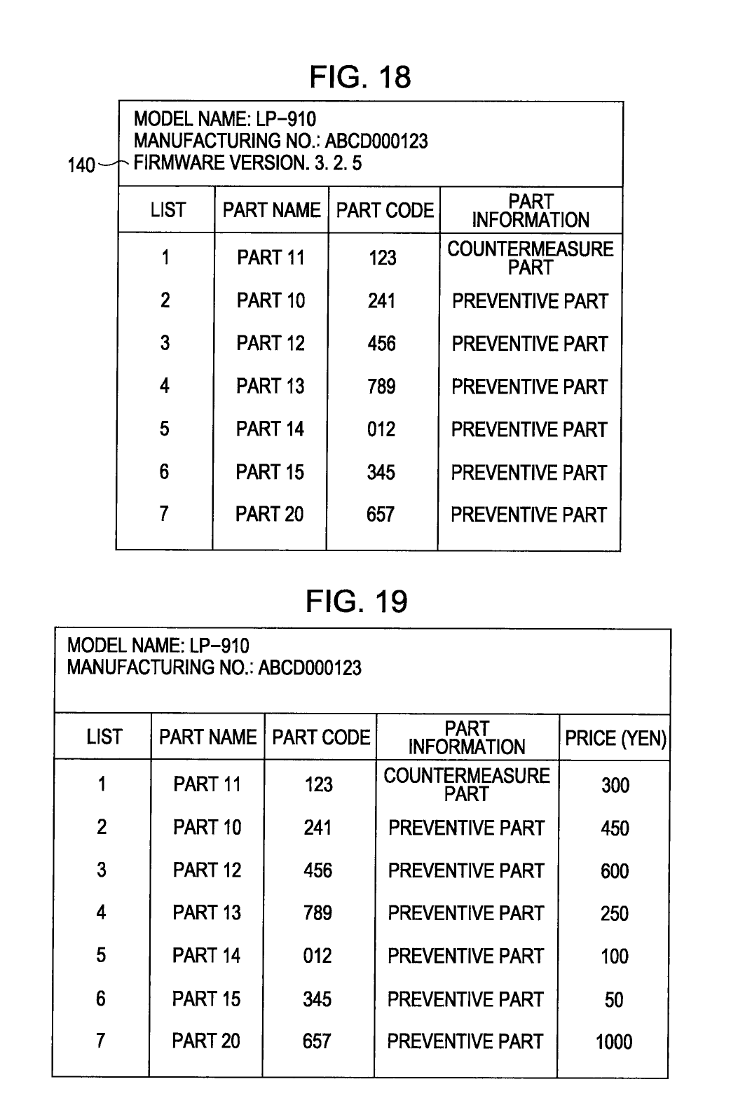

FIG. 18 is a view illustrating a display example of replacement information computed by the maintenance work support device according to the fourth embodiment. In the replacement information illustrated in FIG. 18, a firmware version of the inspection target device 7 is displayed as denoted by reference numeral 140. The firmware version is read out from device information of the inspection target device 7 of the user previously stored in the storage unit 12, retrieved based on the serial number of the inspection target device 7, and displayed.

The maintenance worker can determine whether or not the firmware of the inspection target device 7 at the present time is the latest version with reference to the displayed version information and perform the maintenance work of, for example, downloading the firmware of the latest version to the inspection target device 7 when the firmware is not the latest version.

Next, a fifth embodiment of the maintenance work support device will be described.

FIG. 19 is a view illustrating a display example of replacement information computed by the maintenance work support device according to the fifth embodiment. In the replacement information illustrated in FIG. 19, the price of each part is displayed in association with a corresponding part. Each part and the price thereof are previously stored in the storage unit 12 in association with each other, and when the server 3 computes and displays replacement information on the portable terminal 5, the price is also read out and displayed.

For example, the fifth embodiment is effective in the case of maintenance work for a user paying a price for the part when replacing a part other than the countermeasure part, even when the user has a maintenance agreement. Further, the maintenance worker can display and explain both the amount of the replacement rate and the price of the part on the display unit 23 of the portable terminal 5. The user can also establish a need or a schedule for maintenance while referring to the replacement rate or the price.

Next, a sixth embodiment of the maintenance work support device will be described.

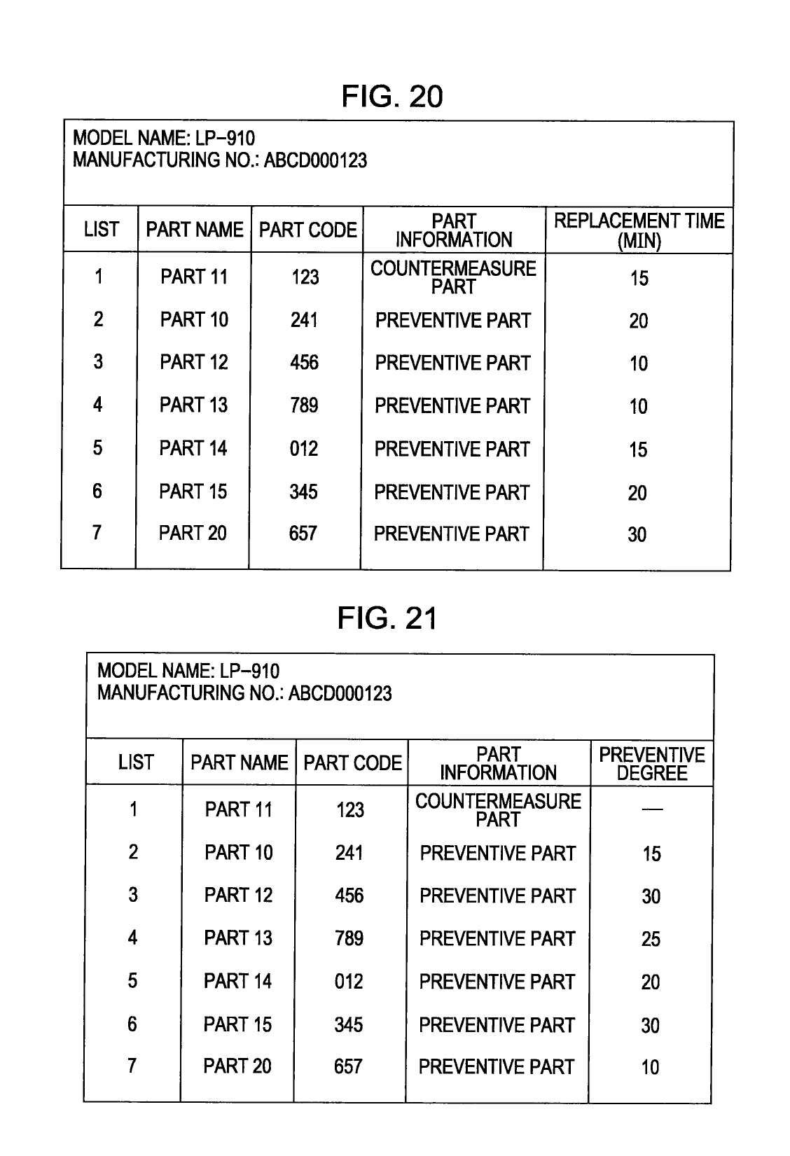

FIG. 20 is a view illustrating a display example of replacement information computed by the maintenance work support device according to the sixth embodiment. In the replacement information illustrated in FIG. 20, time (replacement time) taken for a replacement work of each part is displayed. Each part and replacement time thereof are previously stored in the storage unit 12, and when the server 3 computes the replacement time and displays the replacement time on the portable terminal 5, the server 3 reads out and displays the replacement time as well.

The sixth embodiment is effective when the maintenance worker explains the time necessary for the replacement work to the user and effective when the inspection target device 7 needs to be stopped for the part replacement or when making a schedule for the maintenance work since the user is busy.

Next, a seventh embodiment of the maintenance work support device will be described.

FIG. 21 is a view illustrating a display example of replacement information computed by the maintenance work support device according to the seventh embodiment. In the replacement information illustrated in FIG. 21, a preventive degree for each part is displayed. The preventive degree is a value corresponding to the replacement rate to be displayed in the replacement record information, and for example, when the replacement rate is 30%, the preventive degree is displayed as 30%. The preventive degree is stored in the storage unit 12 in association with each part, and when the server 3 computes the replacement information and displays the replacement information on the portable terminal 5, the server 3 reads out and displays the preventive degree. It is also possible to correct and display the preventive degree according to the installation rank. For example, the maintenance worker can display a reference preventive degree and the preventive degree of each installation rank on the display unit 23 of the portable terminal 5 and explain how the preventive degree changes according to the installation state to the user.

Next, an eighth embodiment of the maintenance work support device will be described.

In the first embodiment, whether each part is the countermeasure part or the preventive part is determined and stored in the storage unit 12, but in the eighth embodiment, a replacement target part is determined as the countermeasure part or the preventive part according to the business type or work state of the user and stored.

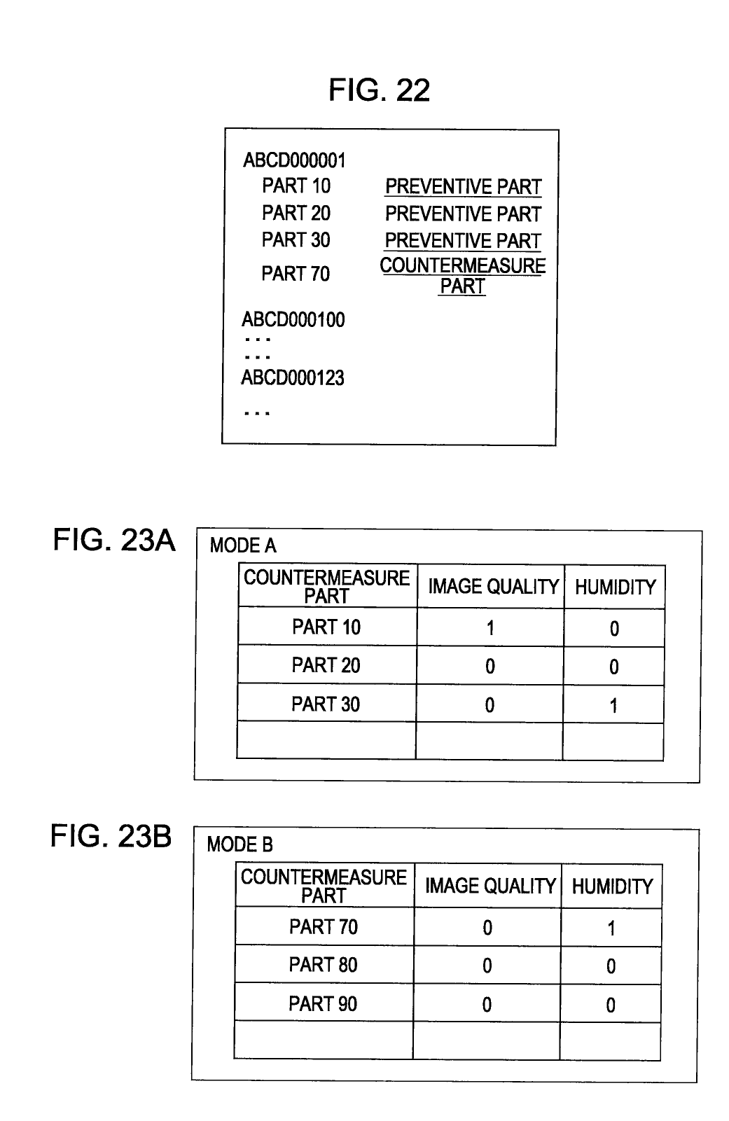

FIG. 22 is a view illustrating a part classification of each inspection target device 7. FIG. 23 is a view illustrating a classification of a part determined by a business type. In a part classification of a reference use environment illustrated in FIG. 22, the parts 10 and the parts 30 are the preventive parts. FIG. 23A illustrates a part classification for a business type A. For example, when the business type A is a business in which an image quality (a printing quality) is emphasized, a flag “1” is stored in a quality entry of the part 10, and a flag “1” is stored in a humidity entry of the part 30. The server 3 changes the part 10 and the part 30 from the preventive part to the countermeasure part in the part classification for the business type A and performs replacement information computation processing described above. As a result, it is possible to perform the maintenance according to a performance necessary for a business type by using the countermeasure part instead of the preventive part.

In the part classification of the reference use environment illustrated in FIG. 22, the part 70 is the countermeasure part. FIG. 23B illustrates the part classification for a business type B. In the business type B, when the humidity is lower than in a reference environment, a flag “1” is stored in a humidity entry of the part 70. The server 3 changes the part 70 from the countermeasure part to the preventive part in the part classification for the business type B and performs replacement information computation processing described above. As a result, it is possible to provide the part replacement (the maintenance) according to the use environment, a part having a low possibility of failure is not unnecessarily replaced, the maintenance worker can efficiently perform the work, and the user can reduce the part replacement cost.

Further, whether the part is the countermeasure part or the preventive part may be determined according to the use state of the inspection target device 7 of each user.

Hereinbefore, the exemplary embodiments of the maintenance work support device according to the invention have been described with reference to the accompanying drawings, but the invention is not limited thereto. A person skilled in the art would understand that various modifications or variations can be made within the technical spirit and scope of the invention and come within the technical scope of the invention.

Further, in the embodiments described above, part replacement has been described as an example, but the maintenance work support device can be applied to maintenance without part replacement, for example, overhauling, greasing up, and adjustment of rotation balance.

As described above, according to the invention, it is possible to compute information of a part which needs to be replaced or inspected in consideration of the installation state or quality requirements of a user and improve the quality or the efficiency of the maintenance work.

The entire disclosure of Japanese Patent Application No. 2009-005577, filed Jan. 14, 2009 is expressly incorporated by reference herein.

What is claimed is:

1. A maintenance work support device which computes replacement information of a part which configures a device and supports a maintenance work of the device, comprising:
a storage unit which stores various information; and
a control unit which controls the maintenance work support device according to information stored in the storage unit,
wherein the storage unit comprises:
a quality information storage unit which stores identification information and a replacement state for improving a quality of a part which configures the device as quality information;
a replacement history information storage unit which stores identification information of the device and a replacement state by a past failure of a part which configures the device as replacement history information; and
a replacement record information storage unit which stores a replacement record of a part which configures the device and a use state of the device in association with each other as replacement record information, and
the control unit comprises:
a replacement information computation unit which retrieves quality information, replacement history information, and replacement record information of a part which configures the device based on identification information and a use state of a device which is an inspection target and computes information of a part which configures the device and needs to be replaced as replacement information based on the retrieval result.

2. The maintenance work support device according to claim 1, wherein the replacement record information is corrected by installation information of the device.

3. The maintenance work support device according to claim 2, wherein the installation information is any of a business type of a user of the device, and temperature, humidity, and an ambient contamination state of an installation place of the device, or a combination thereof.

4. The maintenance work support device according to claim 1, wherein the replacement record information is information representing a corresponding part as the part which needs to be replaced when a replacement rate of a part which configures the device exceeds a predetermined reference value.

5. The maintenance work support device according to claim 1, wherein the replacement record information is information representing a corresponding part as the part which needs to be replaced when a replacement rate rank of a part which configures the device exceeds a predetermined reference value.

6. The maintenance work support device according to claim 1, wherein the replacement information includes information regarding a firmware which is installed in the device and needs to be updated.

7. The maintenance work support device according to claim 1, wherein the replacement information includes information regarding a price of a part which configures the device and needs to be replaced.

8. The maintenance work support device according to claim 1, wherein the replacement information includes information regarding time taken for a replacement work of a part which configures the device and needs to be replaced.

9. The maintenance work support device according to claim 1, further comprising: an output unit which outputs the replacement information.

10. The maintenance work support device according to claim 9, wherein the output unit outputs the replacement information on a terminal device which is connected to the maintenance work support device according to claim 1 to transmit and receive data.

11. The maintenance work support device according to claim 1, wherein input of identification information of the device which is the inspection target is received from a terminal device which is connected to the maintenance work support device according to claim 1 to transmit and receive data.

12. The maintenance work support device according to claim 1, wherein the replacement information computation unit classifies parts which configure the device and need to be replaced into replacement parts for improving the quality of the device or replacement parts for preventing a failure and computes the replacement information.

13. The maintenance work support device according to claim 1, wherein the replacement information computation unit computes a replacement rate of a corresponding part as a preventive degree with respect to a part classified as a replacement part for preventing a failure among parts which configure the device and need to be replaced.

14. The maintenance work support device according to claim 10, wherein the output unit outputs and displays both replacement information computed by using the replacement record information corrected by the installation information of the device and replacement information computed by normal replacement record information which is not corrected on a terminal device which is connected to the maintenance work support device according to claim 1 to transmit or receive data.

15. A maintenance work support method of computing replacement information of a part which configures a device and supporting maintenance work of the device, comprising:
storing identification information and a replacement state for improving a quality of a part which configures the device as quality information;
storing identification information of the device and a replacement state by a past failure of a part which configures the device as replacement history information;
storing a replacement record of a part which configures the device and a use state of the device in association with each other as replacement record information; and
retrieving quality information, replacement history information, and replacement record information of a part which configures the device based on identification information and a use state of a device which is an inspection target and computing information of a part which configures the device and needs to be replaced as replacement information based on the retrieval result.

16. A program which causes a computer to function as:
a quality information storage unit which stores identification information and a replacement state for improving a quality of a part which configures the device as quality information;
a replacement history information storage unit which stores identification information of the device and a replacement state by a past failure of a part which configures the device as replacement history information;
a replacement record information storage unit which stores a replacement record of a part which configures the device and a use state of the device in association with each other as replacement record information; and
a replacement information computation unit which retrieves quality information, replacement history information, and replacement record information of a part which configures the device based on identification information and a use state of a device which is an inspection target and computes information of a part which configures the device and needs to be replaced as replacement information based on the retrieval result.
